(19) United States
(12) Patent Application Publication
(10) Pub. No.: US 2015/0214797 A1
(43) Pub. Date: Jul. 30, 2015

(54) THREE-DIMENSIONAL AXIAL GAP TYPE ROTATING ELECTRIC MACHINE

(71) Applicant: NIPPON PISTON RING CO., LTD, Saitama-shi (JP)

(72) Inventors: Masafumi SAKAMOTO, Saitama-shi (JP); Shigeyoshi SATO, Saitama-shi (JP); Shunsuke TAKEGUCHI, Saitama-shi (JP)

(73) Assignee: NIPPON PISTON RING CO., LTD, Saitama-shi (JP)

(21) Appl. No.: 14/602,569

(22) Filed: Jan. 22, 2015

(30) Foreign Application Priority Data
Jan. 28, 2014 (JP) 2014-013723

(51) Int. Cl. H02K 1/27; H02K 1/02

(52) U.S. Cl. CPC H02K 1/2793; H02K 1/02

(57) ABSTRACT

An axial gap type rotating electric machine including a stator that includes m salient poles that protrude from a discoid magnetic material in a rotating shaft direction and are arranged in a circumferential direction. A winding wire is wound around an outer periphery of each of the salient poles. The rotor includes n permanent magnet poles and n rotor magnetic materials that are alternately arranged in the circumferential direction. The permanent magnet poles each include a magnet pole piece and a permanent magnet that are fixedly attached to each other and arranged in an axial direction, the magnet pole piece being made of a magnetic material. A plurality of teeth are formed in a concentric arc-like manner in an opposing part between: the magnet pole pieces and the rotor magnetic materials; and the stator so as to engage with each other with the intermediation of the air gap.

### BACKGROUND OF THE INVENTION

1. Field of the Invention

The present invention relates to an axial gap type rotating electric machine used as an electric motor and a power generator.

2. Description of the Related Art

Reduction in weight, thickness, and length of rotating electric machines used as electric motors and power generators is strongly required in the market. In recent years, improvement in energy saving and efficiency of rotating electric machines is also increasingly required in order to address global warming. Reduction in vibration, noise, and cost of rotating electric machines is also strongly required. Under the circumstances, an axial gap type rotating electric machine having an air gap in a rotating shaft direction has a flattened shape, which is advantageous for reduction in thickness. Further, if a rotor of the axial gap type rotating electric machine is formed in a discoid shape, inertia thereof can be reduced, and hence the axial gap type rotating electric machine is suitable for both a constant speed operation and a variable speed operation, and is one of rotating electric machine modes that attracts attention in recent years. A rotating electric machine having an axial length smaller than an outer diameter thereof, which is a so-called flattened rotating electric machine, has a larger air gap opposing area than that of a radial gap type rotating electric machine, and hence the axial gap type rotating electric machine starts to be revaluated for an in-wheel motor and the like in terms of improvement in torque.

The inventors of the present invention propose Japanese Patent Laid-Open No. 2013-150543 (hereinafter, referred to as Patent Literature 1) as a conventional technique of improving torque in an axial gap type rotating electric machine by increasing an air gap opposing area. Further, a technique of using reluctance torque in a permanent magnet buried type rotor of a radial gap type rotating electric machine is disclosed in “Basics and Applications of Electric Motor Drive”, authored by Hideo DOHMEKI, pp. 131 to 134: Generation and Utilization of Reluctance Torque (hereinafter, referred to as Non Patent Literature 1).

Rotating electric machines are roughly categorized into a radial gap type and an axial gap type. In a case of a rotating electric machine having an axial length smaller than an outer diameter thereof, which is a so-called flattened rotating electric machine, the axial gap type rotating electric machine can secure a larger air gap opposing area than the radial gap type rotating electric machine, and thus can achieve higher torque.

In a radial gap type rotating electric machine, in a case where a rotor and a stator are formed by laminating silicon steel plates, a magnetic path is a so-called two-dimensional magnetic path, which is formed on a plane perpendicular to a rotating shaft, in many cases, and hence the laminating method is suitable. In comparison, in an axial gap type rotating electric machine, a magnetic path is a so-called three-dimensional magnetic path, which is formed in both a rotating shaft direction and a direction of a plane perpendicular to the rotating shaft, and hence the method of laminating silicon steel plates is not suitable because the magnetic path in the rotating shaft direction is formed in a lamination direction and a magnetic resistance thus increases. This is one of reasons why the axial gap type rotating electric machine does not become more popular than the radial gap type rotating electric machine. A known countermeasure against this is to use a pressed powder core and a sintered core. With regard to a winding wire, a brushless DC motor (hereinafter, referred to as BLDC motor) and a synchronous power generator, in which a permanent magnet is used for a rotor, or a switched reluctance motor (hereinafter, referred to as SR motor), in which a permanent magnet is not used for a rotor and teeth of a magnetic material are provided instead, are used as general axial gap type rotating electric machines. According to a technique for the BLDC motor and the synchronous power generator or the SR motor, a winding wire is wound in a concentrated manner in a case of placing importance on efficiency and reduction in cost. The reason for this is as follows. If a winding wire is wound in a distributed manner, a coil end part that does not contribute to torque generation becomes large, a copper loss increases, and efficiency decreases. In comparison, if a winding wire is wound in a concentrated manner, the winding wire is simple and can be wound directly in a slot, so that the winding wire can be inexpensive. Moreover, winding wire insertion is easier in the axial gap type rotating electric machine than in the radial gap type rotating electric machine, and hence the axial gap type rotating electric machine can be inexpensive and can improve a coil space factor. Patent Literature 1 that adopts a device for increasing the air gap opposing area between a stator and a rotor is an example of pursuing improvement in efficiency of a rotating electric machine.

In the axial gap type rotating electric machine described in Patent Literature 1, teeth of the stator and teeth of the rotor three-dimensionally engage with each other in a concavo-convex manner with the intermediation of an air gap. This is advantageous to improvement in torque, and a pressed powder core capable of three-dimensional shaping is advantageous. The pressed powder core is obtained by mixing a small amount of resin as a binder for insulating an eddy current, to soft magnetic iron powder, pressurizing and shaping the mixture, and then sintering the shaped mixture.

Unfortunately, the axial gap type rotating electric machine described in Patent Literature 1 simply relates to a BLDC motor in which a permanent magnet is used for the rotor and torque based on IBL in Fleming's left-hand rule is used, or to a SR motor in which a permanent magnet is not used for the rotor. Hence, Patent Literature 1 is limited in further improvement in torque, rotation speed, and efficiency.

### SUMMARY OF THE INVENTION

The present invention has been made in order to solve the above-mentioned disadvantages.

The rotating electric machine described in Non Patent Literature 1 is a radial gap type rotating electric machine, and Non Patent Literature 1 describes a technique of using reluctance torque in a permanent magnet buried type rotor. The present invention makes this technique applicable to an axial gap motor, and achieves further improvement in torque, rotation speed, and efficiency compared with Patent Literature 1, along with a synergetic effect with a three-dimensional air gap, to thereby solve the above-mentioned disadvantages of the conventional technique.

The present invention is achieved by the following solutions.

The present invention provides an axial gap type rotating electric machine including: a stator and a rotor that are opposed to each other with an intermediation of an air gap; and a winding wire axis and a rotating shaft parallel to each other. The stator includes m salient-pole parts that protrude from a discoid magnetic material in a rotating shaft direction and are arranged in a circumferential direction. A winding wire is wound around an outer periphery of each of the salient-pole parts. The rotor includes n permanent magnet poles and n rotor magnetic materials that are alternately arranged in the circumferential direction. The permanent magnet poles each include a magnet pole piece and a permanent magnet that are fixedly attached to each other and arranged in an axial direction, the magnet pole piece being made of a magnetic material. Polarities of the permanent magnet poles are alternately arranged in the circumferential direction such that the permanent magnet poles are magnetized into opposite polarities in the axial direction. A plurality of teeth are formed in a concentric arc-like manner in an opposing part between: the magnet pole pieces and the rotor magnetic materials; and the stator so as to engage with each other with the intermediation of the air gap. Note that m is a positive integer, and n is a positive even number. This corresponds to FIG. 5 and FIG. 6 to be described later.

In the axial gap type rotating electric machine according to the present invention, preferably, the permanent magnet poles of the rotor each include two magnet pole pieces and the permanent magnet, the two magnet pole pieces sandwiching the permanent magnet from both sides in the axial direction, and two stators sandwich the rotor from both the sides in the axial direction with the intermediation of the air gap. This corresponds to FIG. 1, FIG. 2, and FIG. 7 to be described later.

In the axial gap type rotating electric machine according to the present invention, preferably, the stator is formed by one of: dividing the m salient-pole parts each including the teeth on both sides in the axial direction and arranging the divided parts in the circumferential direction; and coupling two stators back to back in the axial direction, and two rotors sandwich the stator from both the sides in the axial direction with the intermediation of the air gap. This corresponds to FIG. 3 and FIG. 4 to be described later.

In the axial gap type rotating electric machine according to the present invention, preferably, each of the magnetic materials is at least partially made of one of a sintered core and a pressed powder core.

In the axial gap type rotating electric machine according to the present invention, because the stator teeth and the rotor teeth opposedly engage with each other in the air gap opposing part therebetween, an opposing area increases, and air gap part permeance can be made high, so that the rotating electric machine can be highly efficient. Further, the parts magnetized by the permanent magnets and the magnetic material parts are alternately arranged in the rotor, and hence reluctance torque generated by the magnetic material parts is added to torque based on IBL generated by the permanent magnets. That is, both torque generated by a BLDC motor and torque generated by a SR motor can be obtained. Accordingly, torque can be more improved compared with a case where only the BLDC motor is provided or where only the SR motor is provided.

In the axial gap type rotating electric machine according to the present invention, the stator teeth and the rotor teeth respectively engage with each other in a concentric arc-like manner, and hence the rotating electric machine can be easily assembled by inserting the shaft of the rotor into bearings of the stator, and thus can be inexpensive and highly efficient.

In the axial gap type rotating electric machine according to the present invention, if the stators are respectively arranged on both the sides of the rotor or, conversely, if the rotors are respectively arranged on both the sides of the stator, the rotating electric machine can be small-sized and highly efficient in both cases.

In the axial gap type rotating electric machine according to the present invention, the permanent magnet parts and the magnetic material parts are alternately arranged in the rotor, and hence use of the permanent magnets can be reduced, thus enabling production at less expensive price.

In the axial gap type rotating electric machine according to the present invention, concavo-convex shapes of the tooth parts can be easily formed by stamping using the pressed powder core or the sintered core.

In the axial gap type rotating electric machine according to the present invention, an eddy current loss is close to zero because of the pressed powder core, and an iron loss is low particularly at a high speed. Hence, the rotating electric machine can be highly efficient.

### BRIEF DESCRIPTION OF THE DRAWINGS

FIG. 1 is a cross-sectional view including a shaft of a rotating electric machine according to an embodiment of the present invention;

FIG. 2 is a diagram of a rotor in FIG. 1, which is observed in an axial direction;

FIG. 3 is a cross-sectional view including a shaft of a rotating electric machine according to another embodiment of the present invention;

FIG. 4 is a diagram of a stator in FIG. 3, which is observed in an axial direction;

FIG. 5 is a half cross-sectional view including the shaft of the rotating electric machine in FIG. 1 formed as a one-side gap type rotating electric machine;

FIG. 6 is a half cross-sectional view including the shaft of the rotating electric machine in FIG. 3 formed as a one-side gap type rotating electric machine; and

FIG. 7 is an external view of a stator iron core in FIG. 5 or FIG. 6.

### DETAILED DESCRIPTION OF THE PREFERRED EMBODIMENTS

Hereinafter, description is given with reference to the drawings.

### Embodiments

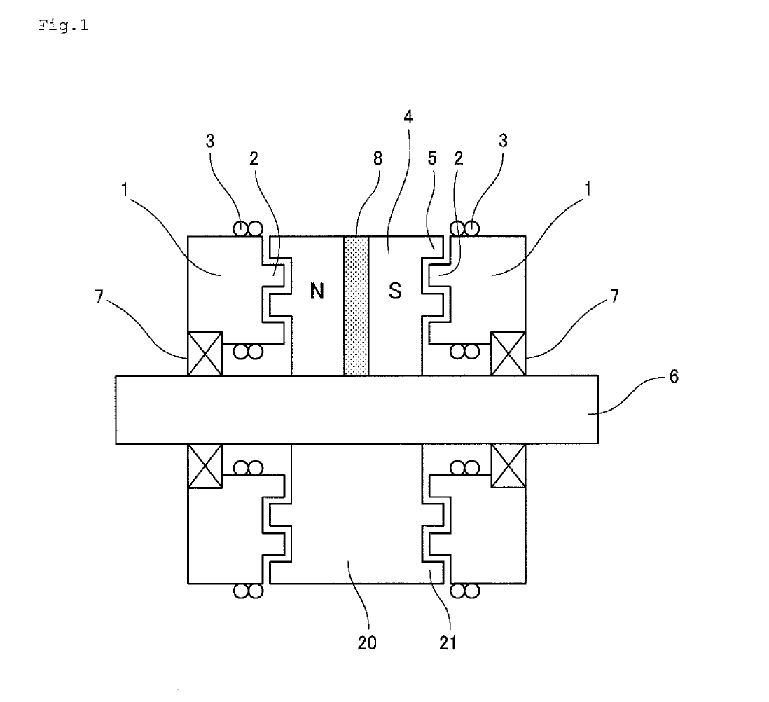

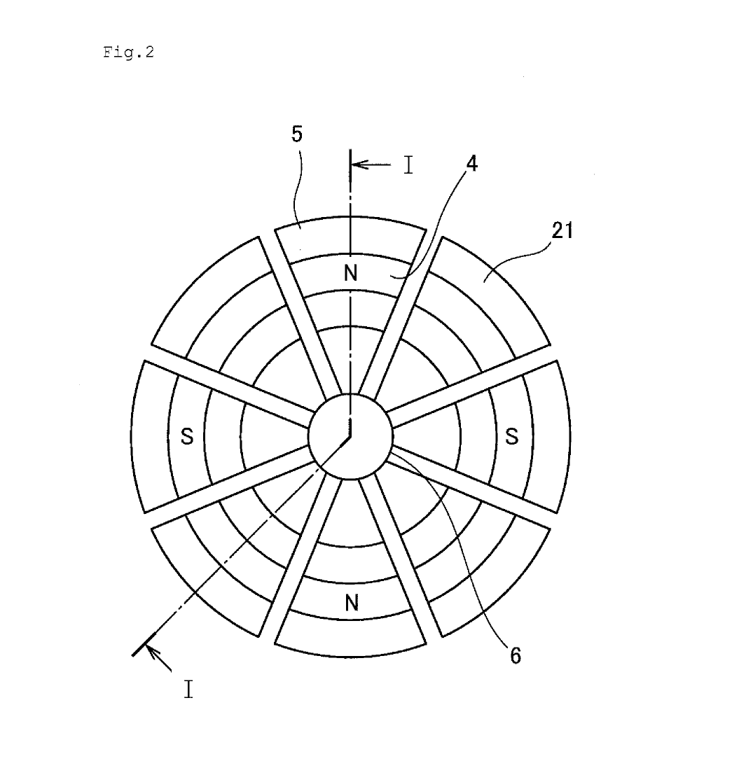

FIG. 1 is a cross-sectional view including a rotating shaft 6 of an axial gap type rotating electric machine according to an example configuration of the present invention, and a cross-section of a rotor part thereof is taken along a line I-I in FIG. 2. FIG. 2 is a diagram of a rotor in FIG. 1, which is observed in an axial direction. FIG. 7 is an external view of a stator in FIG. 1.

An embodiment of the present invention is described with reference to FIG. 1, FIG. 2, and FIG. 7. A stator 1 is a member made of a discoid magnetic material, and includes m winding poles that protrude from the discoid magnetic material in an axial direction. Tooth parts 2 (two in the axial direction) are formed in a concentric arc-like manner in a leading end part of each of the m winding poles. The number of the tooth parts is not limited to two, and a plurality of the tooth parts may be formed. An external view of an iron core part of the stator 1 (in a case where m=6) is illustrated in FIG. 7. A winding wire 3 is wound around each of the m winding poles of the stator iron core 1 that protrude in the axial direction, and the tooth parts 2 are formed in the concentric arc-like manner in the axial direction in this case.

The rotor includes n permanent magnet poles and n rotor magnetic materials that are alternately arranged in a circumferential direction and are fixedly attached to the rotating shaft 6. FIG. 2 is a diagram of the rotor (in a case where n=4), which is observed in the axial direction. Because n represents a pole number, n is more than one.

A rotor magnet pole piece 4 is a member made of a magnetic material. In a state where a permanent magnet 8 is sandwiched between two rotor magnet pole pieces 4, the permanent magnet 8 and the two rotor magnet pole pieces 4 are fixedly attached to the shaft 6 and are rotatably supported by bearings 7. Tooth parts 5 (two in the axial direction) are formed in a concentric arc-like manner in a portion of each rotor magnet pole piece 4, the portion being opposed to the stator in the axial direction. N poles and S poles of n permanent magnets are alternately arranged in a circumferential direction such that the n permanent magnets are magnetized into opposite polarities in the axial direction.

Each rotor magnetic material is denoted by 20. Similarly to the above, tooth parts 21 (two in the axial direction) are formed in a concentric arc-like manner in a portion of each rotor magnetic material 20, the portion being opposed to the stator in the axial direction. The tooth parts 5 and the tooth parts 21 of the rotor are opposed to the tooth parts 2 of the stator with an air gap therebetween so as to respectively engage with the tooth parts 2 of the stator. In this case, in order to avoid short-circuiting of the permanent magnets 8, it is desirable to provide a gap between adjacent parts of each rotor magnet pole piece 4 and each rotor magnetic material 20 or interpose a non-magnetic material therebetween and use a non-magnetic metal material for the shaft 6 as appropriate. In FIG. 2, each rotor magnet pole piece 4 has a substantially fan-shape, and hence it is desirable that a shape observed in the axial direction, of each permanent magnet 8 provided on a back side of the rotor magnet pole piece 4 also have a same shape, that is, a substantially fan-shape. Each rotor magnetic material 20 is also illustrated in a substantially fan-shape. Such a fan-shape is desirable in terms of effective utilization of a gap opposing area, but the present invention is not limited thereto, and a trapezoidal shape and a rectangular shape may be adopted as appropriate.

A rotating electric machine having the following advantages is achieved by adopting such a configuration as described above. That is, because the stator teeth and the rotor teeth opposedly engage with each other in an air gap opposing part therebetween, an opposing area increases, and air gap part permeance can be made high, so that the rotating electric machine can be highly efficient. Most of magnetomotive force for enabling passage of a magnetic flux is consumed in the air gap, and the consumption of the magnetomotive force in the air gap can be suppressed because the air gap part permeance can be made high. Further, in an axial gap type rotating electric machine, the stator teeth and the rotor teeth respectively engage with each other in a concentric arc-like manner, and hence the rotating electric machine can be easily assembled by inserting the shaft of the rotor into the bearings of the stator, and thus can be inexpensive and highly efficient. In this case, a tooth shape for mutual engagement is not limited to the rectangular shape illustrated in the drawings, and may also be other shapes such as a triangular shape and an arc-like shape, as long as the opposing area is larger than that of two-dimensional opposing and rotation in the circumferential direction is possible. In this case, it is considerably difficult to form the stator 1 and the tooth parts 2 or the rotor magnet pole pieces 4 and the tooth parts 5 by laminating silicon steel plates, whereas the formation thereof is easy if pressed powder is used. Moreover, the pole number of the stator is not limited to six. For practical use, the pole number of the stator can be two, four, eight, and twelve in a case of two phases, and can be six, nine, and twelve in a case of three phases. In general, the pole number m of the stator may be a positive integer equal to or more than two. The pole number of the rotor in the example in FIG. 1 to FIG. 3 is four, and combinations of same pole numbers as those in a radial gap type SR motor and a VR STM are possible for the pole number of the rotor. In this case, the shaft 6 rotates together with the rotor.

In a case of a BLDC motor disclosed in Patent Literature 1, a magnetic path in which a magnetic flux from an N pole of a permanent magnet of a rotor passes through an air gap and then returns to an S pole of the permanent magnet is formed, and hence torque Ti based on IBL in Fleming's left-hand rule is generated. However, because magnetic permeability of the permanent magnet part is as low as that of the air, a magnetic flux from a winding wire cannot pass therethrough, and hence reluctance torque cannot be obtained.

In view of the above, according to the present invention, operations in FIG. 1 and FIG. 2 are as described below, and the above-mentioned disadvantage is improved.

As described above, in the rotor of the present invention, each of the permanent magnet pole pieces 4 corresponding to a rotor part for a BLDC motor and each of the rotor magnetic materials 20 corresponding to a rotor part for a SR motor form one pole, and a total of four poles are distributed in the circumferential direction. That is, the rotor of the present invention is configured as a tetrapolar BLDC motor and a tetrapolar SR motor.

These rotor parts share the stator. In the example illustrated in the drawings, the stator has three phases and six winding poles. In this case, a rotating field axis magnetic flux generated by causing, for example, three-phase AC current to flow through the winding wire 3 passes through the tooth parts 21 via the rotor magnetic material 20 in the rotating shaft direction, enters the stator pole on another side, passes through a discoid magnetic material 22 of the stator, enters the rotor magnetic material of the adjacent opposed rotor part, and returns to the original stator, whereby a closed magnetic path is formed. The closed magnetic path rotates at a speed synchronous with the rotating field, and generates reluctance torque Tr in the rotor. Meanwhile, the torque Ti based on IBL is generated between the permanent magnet field and the winding wire current. The reluctance torque Tr and the torque Ti are added to each other to become combined torque T(=Ti+Tr). In this case, with reference to FIG. 2, if a ratio of a permanent magnet pole part opposing area to a rotor magnetic material opposing area is, for example, 2 to 1, the obtained torque can be higher by about 15 to 30% than that in a BLDC motor in which only a permanent magnet is used. Details of the torque generation are described in Non Patent Literature 1, and hence detailed description thereof is omitted here. The reluctance torque in Non Patent Literature 1 is synonymous with the reluctance torque used herein.

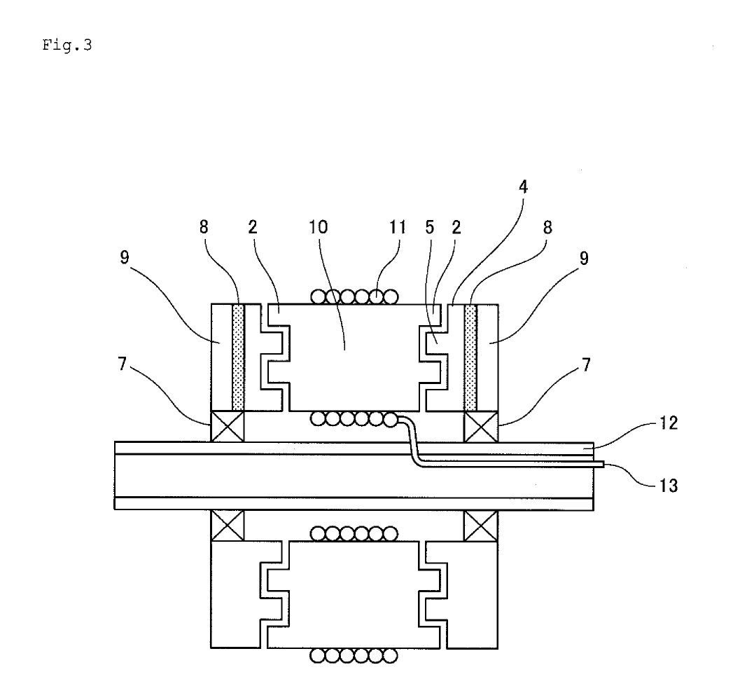

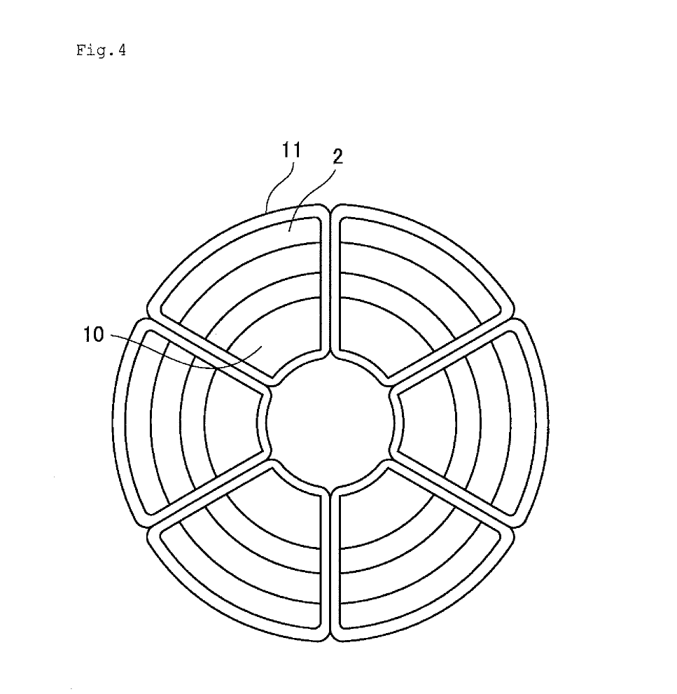

FIG. 3 illustrates an axial gap type rotating electric machine according to another embodiment of the present invention, in which: rotors are respectively provided on both sides of a stator in an axial direction; and the rotors rotate about a fixed shaft 12 fixedly attached to the stator. Because the shaft is fixed, this structure is suitable for an in-wheel motor and the like. FIG. 4 is a diagram of the stator in FIG. 3, which is observed in the axial direction. Components having same functions as those in FIG. 1 and FIG. 2 are denoted by same reference signs, and hence description thereof is omitted. A back yoke 9 of each permanent magnet 8 and a lead wire 13 are drawn out from a hollow part of the fixed shaft 12. A winding wire 11 is wound around an outer periphery of each stator iron core part 10. The tooth parts 2 are formed in a concentric arc-like manner on both sides of each stator iron core part 10 in the axial direction, and are opposed to the tooth parts 5 of the rotors with the intermediation of an air gap. A rotor configuration in the present embodiment is different from that for both-side gap opposing illustrated in FIG. 1 and FIG. 2 in that two rotors for one-side gap opposing are respectively provided on both the sides of the stator in the axial direction. Other rotor configurations are the same as those in FIG. 1 and FIG. 2.

As illustrated in FIG. 4, the stator in FIG. 3 includes substantially fan-shaped radial parts extending in the axial direction. The m salient-pole parts of the stator in FIG. 1 are divided, and the concentric arc-like tooth parts 2 are formed on both sides of each divided part in the axial direction. The m divided parts are equally coupled to each other using resin or non-magnetic metal, and are arranged in a circumferential direction, although illustration of coupling parts is omitted. In this case, the discoid magnetic material 22 of the stator illustrated in FIG. 7 is not provided, and hence an amount of copper of the winding wire 11 can be larger than that of the winding wire 3 in FIG. 1.

Alternatively, although the amount of copper of the winding wire becomes smaller than that in the above-mentioned configuration, two one-side stators (illustrated in FIG. 1) each including the discoid magnetic material 22 may be coupled back to back in the axial direction, and the stator thus configured may be sandwiched between the two rotors from both the sides of the stator in the axial direction with the intermediation of the air gap. With this configuration, work of coupling and fixedly attaching the m divided parts to each other using resin or the like can be eliminated.

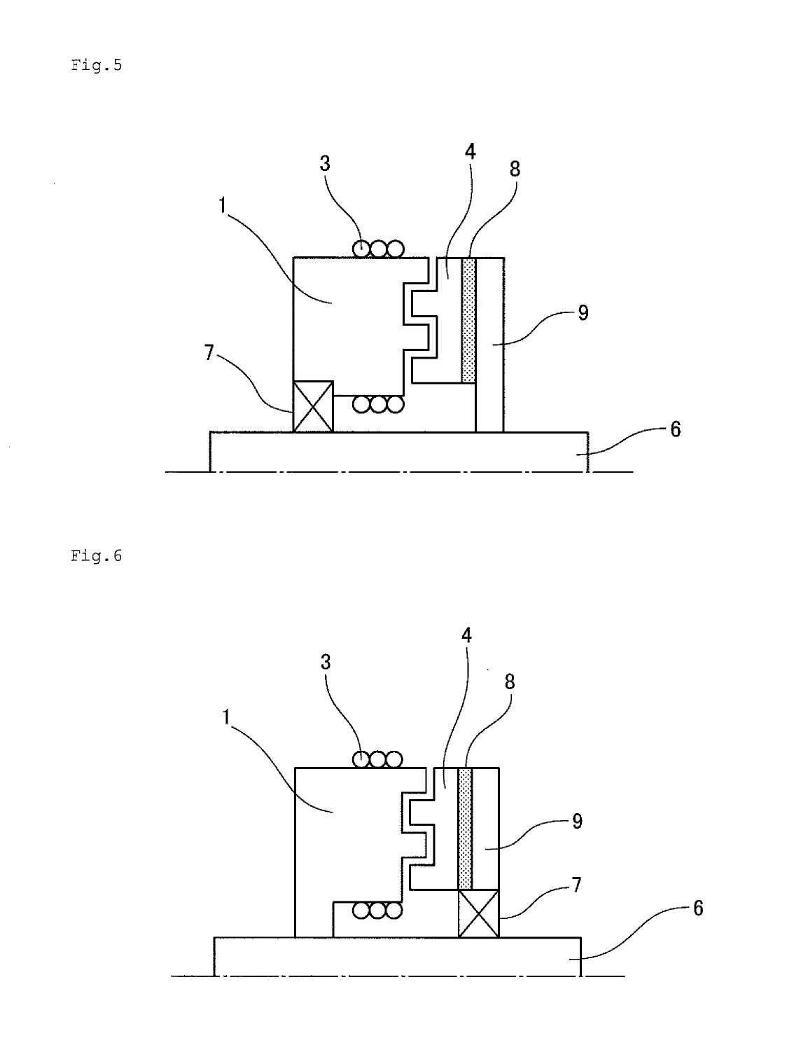

FIG. 5 illustrates a configuration in which the rotating electric machine in FIG. 1 of the present invention is formed as a one-side gap type rotating electric machine. The back yokes 9 of the rotor are fixedly attached to the rotating shaft 6, and the rotating shaft 6 is rotatable. In this case, torque is lower than that in FIG. 1, whereas the rotating electric machine is less expensive.

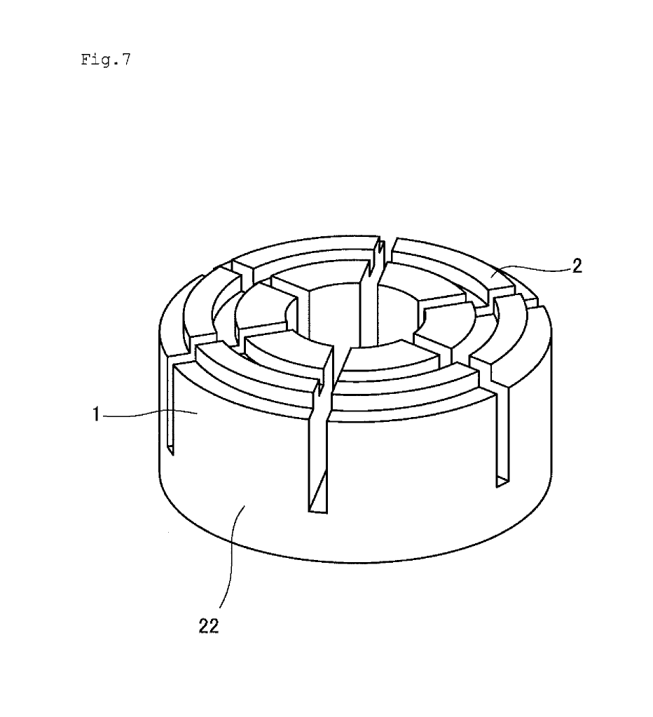

FIG. 6 illustrates a configuration in which the rotating electric machine in FIG. 3 of the present invention is formed as a one-side gap type rotating electric machine. The rotor rotates about the shaft 6 fixedly attached to the stator, and the shaft 6 is fixed. In this case, torque is lower than that in FIG. 3, whereas the rotating electric machine is less expensive.

Diagrams of the conventional technique correspond to FIG. 1 and FIG. 7 of Patent Literature 1, and hence attachment of the diagrams to the present application is omitted. Compared with Patent Literature 1, the present invention enables production at less expensive price while being superior in improvement in torque or efficiency. Accordingly, the present invention is an extremely advantageous invention.

The axial gap type rotating electric machine according to the present invention can be utilized as an electric motor or a power generator, is inexpensive and robust, achieves reduction in weight, thickness, and length, is suitable for improvement in torque and efficiency, and is extremely practical. Accordingly, industrially great contributions of the axial gap type rotating electric machine are expected.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2014-13723 filed on Jan. 28, 2014 including the specification, claims, drawings and summary is incorporated herein by reference in its entirety.

What is claimed is:

1. An axial gap type rotating electric machine comprising:
a stator and a rotor that are opposed to each other with an intermediation of an air gap; and
a winding wire axis and a rotating shaft parallel to each other, wherein
the stator includes m salient-pole parts that protrude from a discoid magnetic material in a rotating shaft direction and are arranged in a circumferential direction,
a winding wire is wound around an outer periphery of each of the salient-pole parts,
the rotor includes n permanent magnet poles and n rotor magnetic materials that are alternately arranged in the circumferential direction,
the permanent magnet poles each include a magnet pole piece and a permanent magnet that are fixedly attached to each other and arranged in an axial direction, the magnet pole piece being made of a magnetic material,
polarities of the permanent magnet poles are alternately arranged in the circumferential direction such that the permanent magnet poles are magnetized into opposite polarities in the axial direction,
a plurality of teeth are formed in a concentric arc-like manner in an opposing part between: the magnet pole pieces and the rotor magnetic materials; and the stator so as to engage with each other with the intermediation of the air gap,
m is a positive integer, and
n is a positive even number.

2. The axial gap type rotating electric machine according to claim 1, wherein
the permanent magnet poles of the rotor each include two magnet pole pieces and the permanent magnet, the two magnet pole pieces sandwiching the permanent magnet from both sides in the axial direction, and
two stators sandwich the rotor from both the sides in the axial direction with the intermediation of the air gap.

3. The axial gap type rotating electric machine according to claim 1, wherein
the stator is formed by one of: dividing the m salient-pole parts each including the teeth on both sides in the axial direction, coupling the divided parts using a non-magnetic material, and arranging the coupled parts in the circumferential direction; and coupling two stators back to back in the axial direction, and
two rotors sandwich the stator from both the sides in the axial direction with the intermediation of the air gap.

4. The axial gap type rotating electric machine according to claim 1 wherein
each of the magnetic materials is at least partially made of one of a sintered core and a pressed powder core.
